(19) United States
(12) Patent Application Publication
(10) Pub. No.: US 2026/0237560 A1
(43) Pub. Date: Aug. 13, 2026

(54) TRANSIENT VOLTAGE PROTECTION DEVICE

(71) Applicant: TDK Corporation, Tokyo (JP)

(72) Inventors: Yoshihiro SHINKAI, Tokyo (JP); Naoyoshi YOSHIDA, Tokyo (JP); Masato HAYATSU, Tokyo (JP); Shunsuke TAKAHASHI, Tokyo (JP); Sota HIRABA, Tokyo (JP)

(73) Assignee: TDK Corporation, Tokyo (JP)

(21) Appl. No.: 19/152,733

(22) PCT Filed: Dec. 15, 2023
(86) PCT No.: PCT/JP2023/045038

§ 371 Date: Jul. 31, 2025

(30) Foreign Application Priority Data
Feb. 10, 2023 (JP) 2023-019334

(51) Int. Cl. H01G 4/005

(52) U.S. Cl. CPC H01G 4/005

(57) ABSTRACT

A transient voltage protection component including: a pair of discharge electrodes disposed facing each other with a gap therebetween; and a discharge inducing part in contact with the pair of discharge electrodes. The discharge electrodes have pores having an average diameter of 0.45-2.04 μm inclusive.

### TECHNICAL FIELD

The present disclosure relates to a transient voltage protection device.

### BACKGROUND

In recent years, as electronic equipment has been having smaller sizes and higher performance, importance has been attached to electronic devices for protecting circuits from transient voltages, such as electrostatic discharge (ESD). For example, Patent Document 1 discloses a transient voltage protection device (a so-called ESD suppressor) including a pair of discharge electrodes facing each other and a discharge inducing portion adjacent to the discharge electrodes. A transient voltage protection device such as that disclosed in Patent Document 1 can have smaller capacitance than that of other ESD protection elements, such as multilayer varistors and Zener diodes, and is suitable for a high-speed transmission circuit, a high-frequency circuit, or the like.

However, demands have been further increasing for a higher transmission speed and a lower drive voltage of electronic equipment; and a transient voltage protection device, such as the one disclosed in Patent Document 1, is expected to have improved ESD resistance while maintaining a low discharge start voltage.

### PRIOR ARTS

### Patent Document

Patent Document 1: WO 2009/098944

### SUMMARY OF INVENTION

### Problem to be Solved by Invention

It is an object of exemplary embodiments of the present disclosure to provide a transient voltage protection device having improved ESD resistance while maintaining a low discharge start voltage.

### Means for Solving the Problem

To achieve the above object, a transient voltage protection device according to a first aspect of the present disclosure includes
a pair of discharge electrodes opposing each other with a gap therebetween; and
a discharge inducing portion in contact with the pair of discharge electrodes,
wherein the pair of discharge electrodes has pores having an average size of 0.45 μm or more and 2.04 μm or less.

Having the above characteristics, the transient voltage protection device according to the first aspect can have improved ESD resistance while maintaining a low discharge start voltage.

Preferably, an area percentage of the pores in a section of the pair of discharge electrodes is 1.0% or more and 12.4% or less.

Preferably, the discharge inducing portion includes a base material including glass, metal particles dispersed in the base material, and ceramic particles dispersed in the base material.

Preferably, the pair of discharge electrodes further includes ceramic particles having an average size of 0.05 μm or more and 0.54 μm or less.

Preferably, the pair of discharge electrodes includes at least one selected from the group consisting of Pd, Ag, and Pt as a main component.

A transient voltage protection device according to a second aspect of the present disclosure includes
a pair of discharge electrodes opposing each other with a gap therebetween; and
a discharge inducing portion in contact with the pair of discharge electrodes,
wherein the pair of discharge electrodes includes ceramic particles having an average size of 0.05 μm or more and 0.54 μm or less.

Having the above characteristics, the transient voltage protection device according to the second aspect can have improved ESD resistance while maintaining a low discharge start voltage, similarly to the first aspect.

Preferably, an area percentage of the ceramic particles in a section of the pair of discharge electrodes is 0.4% or more and 5.1% or less.

Preferably, the ceramic particles include SiO₂ as a main component.

Preferably, the discharge inducing portion includes a base material including glass, metal particles dispersed in the base material, and ceramic particles dispersed in the base material.

Preferably, the pair of discharge electrodes further has pores having an average size of 0.45 μm or more and 2.04 μm or less.

Preferably, the pair of discharge electrodes includes at least one selected from the group consisting of Pd, Ag, and Pt as a main component.

### BRIEF DESCRIPTION OF THE DRAWINGS

FIG. 1 is a perspective view of a transient voltage protection device according to one embodiment of the present invention.

FIG. 2A is a sectional view along a line IIA-IIA shown in FIG. 1.

FIG. 2B is a sectional view along a line IIB-IIB shown in FIG. 1.

FIG. 3A is an example schematic sectional view of a discharge electrode.

FIG. 3B is another example schematic sectional view of the discharge electrode.

FIG. 3C is still another example schematic sectional view of the discharge electrode.

FIG. 4A is a schematic sectional view of a discharge inducing portion.

FIG. 4B is a schematic view of a method of measuring a nearest inter-particle distance between metal particles in the discharge inducing portion.

FIG. 5 is a plan view of a green sheet used in a process of manufacturing the transient voltage protection device.

FIG. 6 is an exploded perspective view of a green chip used in the process of manufacturing the transient voltage protection device.

FIG. 7A is a sectional view of a modified example of the transient voltage protection device.

FIG. 7B is a sectional view of another modified example of the transient voltage protection device.

### DETAILED DESCRIPTION OF INVENTION

Embodiments of the present disclosure are described below with reference to the drawings. The embodiments of the present disclosure described below are exemplifications illustrative of the present disclosure. Constituents, such as numerical values, shapes, materials, and manufacturing steps, according to the embodiments may be modified or changed to the extent that technical problems do not arise. Shapes and the like illustrated in the drawings of the present disclosure do not necessarily match actual shapes and dimensions. This is because the shapes and dimensions in the drawings may be modified for illustration purposes.

### First Embodiment

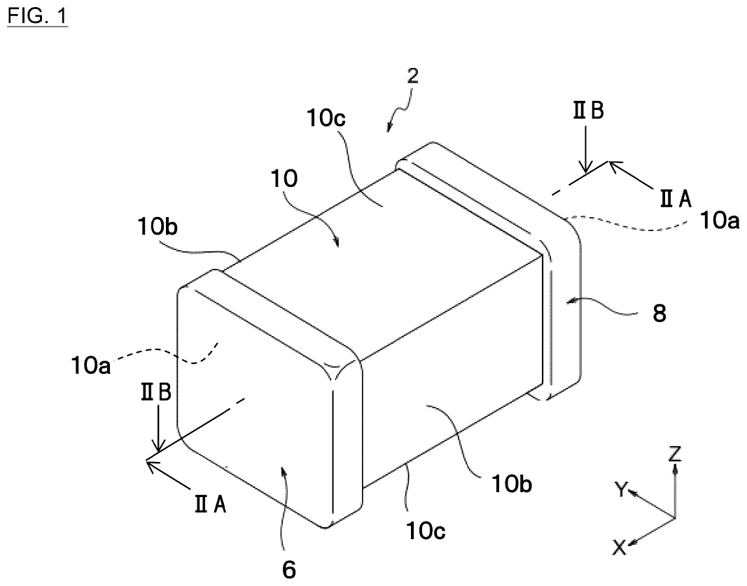

As shown in FIG. 1, a transient voltage protection device 2 according to the present embodiment includes an element body 10 having a hexahedral shape (rectangular parallelepiped shape) and a pair of external electrodes (a first external electrode 6 and a second external electrode 8) provided at outer surfaces of the element body 10.

The element body 10 includes a pair of end surfaces 10a substantially perpendicular to the X-axis, a pair of side surfaces 10b substantially perpendicular to the Y-axis, and a pair of main surfaces 10c substantially perpendicular to the Z-axis. Dimensions of the element body 10 are not limited and are appropriately determined according to a use. Note that, in the drawings, the X-axis, the Y-axis, and the Z-axis are mutually substantially perpendicular.

The first external electrode 6 covers one end surface 10a and extends from the end surface 10a to part of the side surfaces 10b and part of the main surfaces 10c. The second external electrode 8 covers the other end surface 10a and extends from this end surface 10a to part of the side surfaces 10b and part of the main surfaces 10c. The first external electrode 6 and the second external electrode 8 are insulated so as not to be in contact with each other in the X-axis direction.

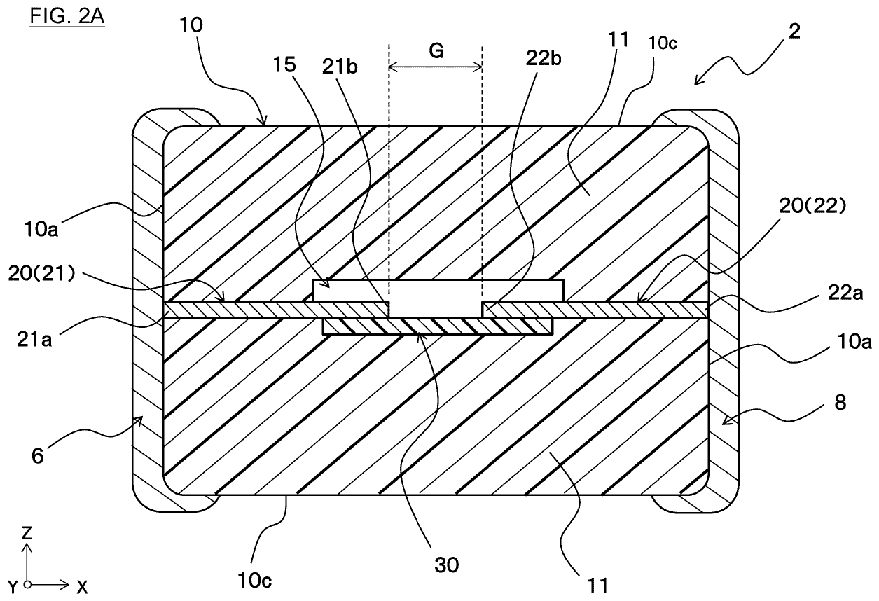

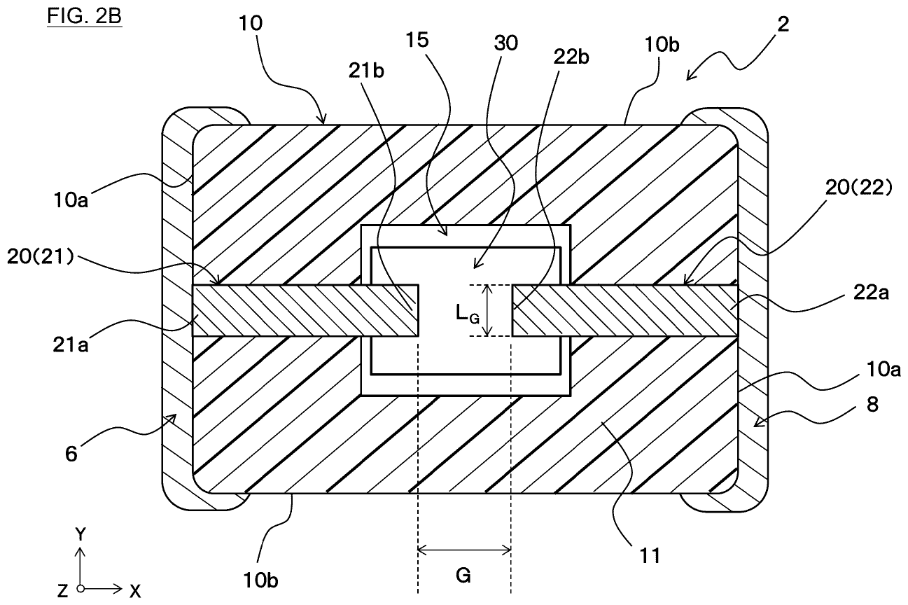

FIG. 2A shows an X-Z section of the transient voltage protection device 2 cut at a substantial center in the Y-axis direction. In contrast, FIG. 2B shows an X-Y section of the transient voltage protection device 2 cut at a substantial center in the Z-axis direction. As shown in FIGS. 2A and 2B, the element body 10 includes insulation layers 11, a pair of discharge electrodes 20, a discharge inducing portion 30, and a cavity 15.

All of the insulation layers 11 are electrically insulating sintered bodies and are laminated along the Z-axis direction. The insulation layers 11 are integrally provided to the extent that boundaries between the layers cannot be visually recognized. The thickness and the number of the insulation layers 11 are not limited and are appropriately determined according to the dimensions of the element body 10.

One discharge electrode electrically connected to the first external electrode 6 among the discharge electrodes 20 is referred to as a “first discharge electrode 21”, and the other discharge electrode electrically connected to the second external electrode 8 is referred to as a “second discharge electrode 22”. Note that, when the term “discharge electrode 20” or “discharge electrodes 20” is collectively used in the following description, the description is illustrative of characteristics common to both the first discharge electrode 21 and the second discharge electrode 22.

Each discharge electrode 20 is an electrode layer having a rectangular shape in plan view and is interposed between predetermined insulation layers 11. The average thickness T_{DE} of each discharge electrode 20 is not limited. T_{DE} may be, for example, 2 μm or more and 20 μm or less or preferably 3 μm or more and 10 μm or less. The first discharge electrode 21 and the second discharge electrode 22 may have different average thicknesses but preferably have approximately the same average thickness.

Both the first discharge electrode 21 and the second discharge electrode 22 are laminated on the same insulation layer 11. The distances between the main surfaces 10c and the first discharge electrode 21 in the Z-axis direction and the distances between the main surfaces 10c and the second discharge electrode 22 in the Z-axis direction are substantially the same. That is, the first discharge electrode 21 and the second discharge electrode 22 are located at approximately the same height in the Z-axis direction. However, the first discharge electrode 21 and the second discharge electrode 22 are disposed apart from each other so as not to be in direct contact with each other in the X-axis direction.

The first discharge electrode 21 includes a lead-out portion 21a and an opposing portion 21b. The lead-out portion 21a is an end portion of the first discharge electrode 21 facing outward in the X-axis direction. The lead-out portion 21a is exposed from the corresponding end surface 10a of the element body 10 and is electrically connected to the first external electrode 6. In contrast, the opposing portion 21b is an end portion of the first discharge electrode 21 facing inward in the X-axis direction. The opposing portion 21b is located in the cavity 15 and opposes an opposing portion 22b of the second discharge electrode 22.

The second discharge electrode 22 includes a lead-out portion 22a and the opposing portion 22b. The lead-out portion 22a is an end portion of the second discharge electrode 22 facing outward in the X-axis direction. The lead-out portion 22a is exposed from the corresponding end surface 10a of the element body 10 and is electrically connected to the second external electrode 8. In contrast, the opposing portion 22b is an end portion of the second discharge electrode 22 facing inward in the X-axis direction. The opposing portion 22b is located in the cavity 15 and opposes the opposing portion 21b of the first discharge electrode 21.

The opposing portions 21b and 22b are apart in the X-axis direction; and between the opposing portions 21b and 22b is a gap G. When a voltage not smaller than a predetermined voltage is applied between the first external electrode 6 and the second external electrode 8, electric discharge occurs at the gap G. The transient voltage protection device 2 assumes a role in preventing application of a transient voltage to a device under protection (DUP) using the above electric discharge between the opposing portions 21b and 22b.

Note that the width of the gap G in the X-axis direction is not limited. The width is appropriately determined so that desired discharge characteristics are exhibited. The width of the gap G in the X-axis direction may be, for example, 10 μm or more and 150 μm or less or preferably 30 μm or more and 100 μm or less. The length L_{G} of the opposing portions of the discharge electrodes opposing each other on the discharge inducing portion 30 (length of each opposing portion (21b, 22b) in the Y-axis direction) is not limited. The length L_{G} may be, for example, 10 μm or more and 500 μm or less or preferably 30 μm or more and 200 μm or less. The ratio (L_{G}/G) of the length L_{G} to the width of the gap G in the X-axis direction may be, for example, 0.1 or more and 30 or less or preferably 0.5 or more and 10 or less.

The discharge inducing portion 30 is laminated below the discharge electrodes 20 along the Z-axis so that the discharge inducing portion 30 is in contact with both discharge electrodes 20 in the lamination direction. In other words, the discharge inducing portion 30 extends from the first discharge electrode 21 to the second discharge electrode 22 and connects the opposing portions 21b and 22b. The discharge inducing portion 30 has a substantially rectangular shape in plan view viewed from the lamination direction. Preferably, the width of the discharge inducing portion 30 in the X-axis direction is larger than the width of the gap G, and the length of the discharge inducing portion 30 in the Y-axis direction is larger than the length of the opposing portions (21b, 22b) in the Y-axis direction. The average thickness T_{AE} of the discharge inducing portion 30 is not limited and is preferably, for example, 1 μm to 15 μm. The discharge inducing portion 30 has a function of readily causing electric discharge between the first discharge electrode 21 and the second discharge electrode 22.

The cavity 15 is a space formed by burning out an organic component (lacquer) in a process of manufacturing the transient voltage protection device 2. As shown in FIG. 2A, surfaces defining the cavity 15 include surfaces of the first discharge electrode 21 in the vicinity of the opposing portion 21b, surfaces of the second discharge electrode 22 in the vicinity of the opposing portion 22b, a surface of the discharge inducing portion 30, and a lower surface of the insulation layer 11 located above the discharge electrodes 20. The shape or dimensions of the cavity 15 are not limited; however, the cavity 15 is provided so as to preferably cover the opposing portions of the discharge electrodes 20 and the discharge inducing portion 30 viewed from the lamination direction. The cavity 15 has a function of absorbing thermal expansion of the first discharge electrode 21, the second discharge electrode 22, the insulation layers 11 adjacent to the discharge electrodes 20, and the discharge inducing portion 30 at the time of electric discharge.

Now, characteristics of materials and the like of each constituent are described in detail.

The insulation layers 11 are composed of an insulating inorganic compound; and the composition of the insulation layers 11 is not limited. The insulation layers 11 may contain, for example, one inorganic compound or at least two inorganic compounds selected from Fe₂O₃, NiO, copper oxide (CuO, Cu₂O), ZnO, MgO, SiO₂, TiO₂, MnCO₃, SrCO₃, CaCO₃, BaCO₃, Al₂O₃, ZrO₂, and B₂O₃. In particular, the insulation layers 11 preferably contain ZrO₂ or/and copper oxide. In a situation where at least two inorganic compounds are contained, these inorganic compounds may be present as a complex compound (e.g., CaZrO₃). The insulation layers 11 may also contain, together with the above inorganic compound or compounds, glass or a subcomponent compound containing a rare-earth element or the like.

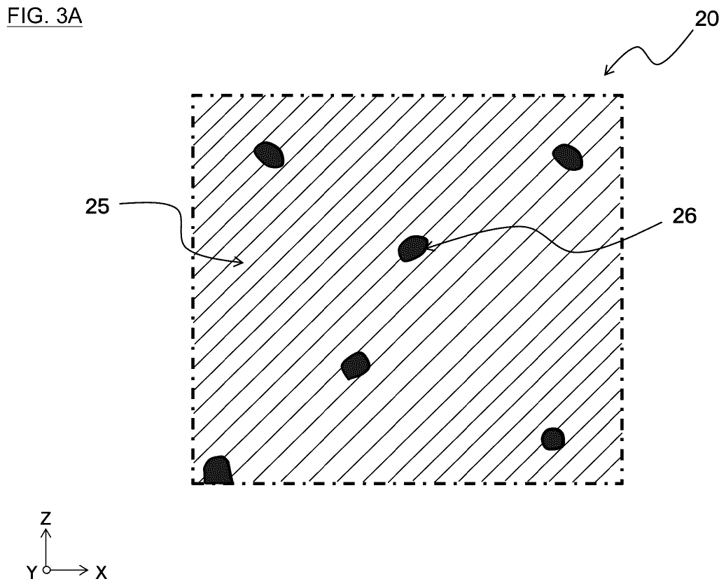

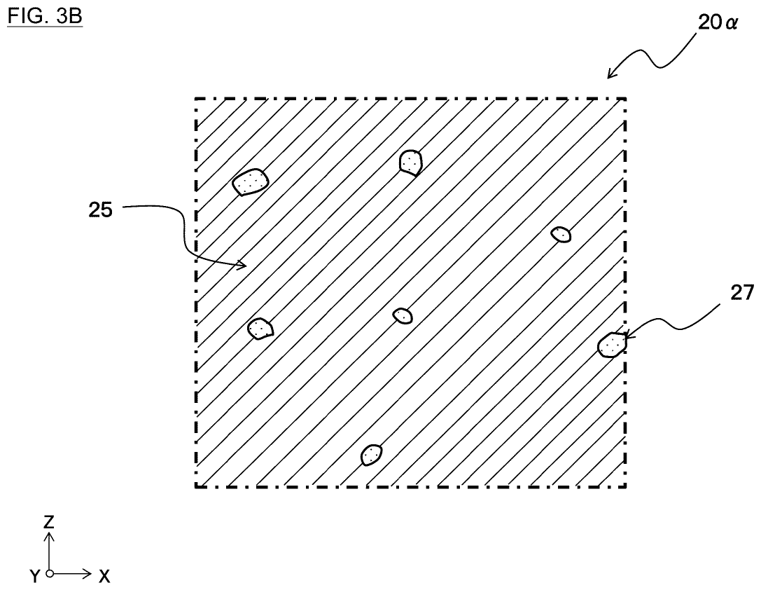

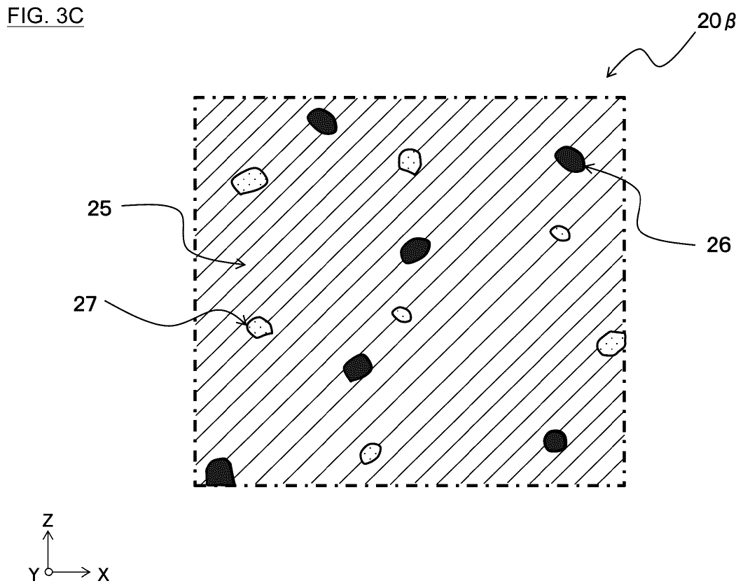

The discharge electrodes 20 are sintered body layers of conductive metal. As shown in FIG. 3A, the discharge electrodes 20 of the present embodiment include or have a metal conductor portion 25 and pores 26, which are discontinuously scattered in the metal conductor portion 25.

The metal conductor portion 25 is a base material (matrix phase) of the discharge electrodes 20 and contains the conductive metal, which is a main component of the discharge electrodes 20. The metal conductor portion 25 may contain, for example, Ag, Pd, Au, Pt, Cu, Ni, Al, Mo, W, or an alloy containing at least one of these metal elements (e.g., a Ag—Pd alloy), as the conductive metal. In particular, the metal conductor portion 25 preferably contains at least one of Pd, Ag, and Pt as a main component; and at least one of Pd, Pt, and a Ag—Pd alloy is preferably used. The main component of the discharge electrodes 20 may constitute 30 wt % or more, preferably 50 wt % or more, more preferably 80 wt % or more, or still more preferably 90 wt % or more of the discharge electrodes 20.

Note that the first discharge electrode 21 and the second discharge electrode 22 may include different main components but preferably include the same kind of main component. The discharge electrodes 20 may also contain a trace amount (e.g., 1 wt % or less) of non-metal components, such as S and P.

The pores 26 of the discharge electrodes 20 have an average size d_{P} of 0.45 μm or more and 2.04 μm or less. The average size d_{P} of the pores 26 is preferably 0.60 μm or more and 1.60 μm or less or is more preferably 0.80 μm or more and 1.30 μm or less.

The average size d_{P} of the pores 26 is an arithmetic mean of equivalent circle diameters of the pores 26 in a section of the discharge electrodes 20. The average size d_{P} is calculated through an image analysis of a sectional image resulting from observation of the section of the discharge electrodes 20 using a scanning electron microscope (SEM), a scanning transmission electron microscope (STEM), or the like. Specifically, respective areas of the pores 26 observed in the section are measured to identify the respective equivalent circle diameters of the pores 26 from their areas. In this analysis, preferably, equivalent circle diameters of at least one hundred pores 26 are identified to calculate the average size d_{P}. Note that, in a TEM image or a STEM image capturing the section of the discharge electrodes 20, the metal conductor portion 25 and the pores 26 can be distinguished based on contrast.

The pores 26 having the above average size d_{P} are inclusions in the discharge electrodes 20. It is assumed that the pores 26 slightly increase electrical resistance of the inside of the discharge electrodes 20 to the extent that their function as electrodes is not impaired. It has been assumed that discharge electrodes of a conventional transient voltage protection device should not have inclusions such as the pores 26 and should have high conductivity (low electrical resistance). In contrast, it is assumed that, in the transient voltage protection device 2 according to the present embodiment, the pores 26 having an average size d_{P} of 0.45 μm or more and 2.04 μm or less obstruct transfer of electric charge inside the discharge electrodes 20, making it easier for a current to flow at surfaces of the discharge electrodes 20 than inside of the discharge electrodes 20. It is thus assumed that the current concentrates more at the surfaces of the discharge electrodes 20 than inside the discharge electrodes 20 to make it easier for electric discharge generated at the gap G between the discharge electrodes 20 to be dispersed. Consequently, ESD resistance becomes better than its conventional value.

The ratio (d_{P}/T_{DE}) of the average size d_{P} of the pores 26 to the average thickness T_{DE} of the discharge electrodes 20 may be, for example, 0.03 or more and 0.35 or less or preferably 0.05 or more and 0.25 or less. The area percentage of the pores 26 in a section of the discharge electrodes 20 is preferably 1.0% or more and 12.4% or less or more preferably 4.0% or more and 10.0% or less.

Similarly to the analysis of the average size d_{P}, the area percentage of the pores 26 is calculated through an image analysis of a section of the discharge electrodes 20. Specifically, the area percentage of the pores 26 can be represented by (A_{P}/A_{DE})×100, where A_{DE} denotes the total area of the analyzed section of the discharge electrodes 20 and A_{P} denotes the total area of the pores 26 in the analyzed section. When the area percentage of the pores 26 is calculated, preferably, multiple sectional images are analyzed to set A_{DE} to at least 400 μm².

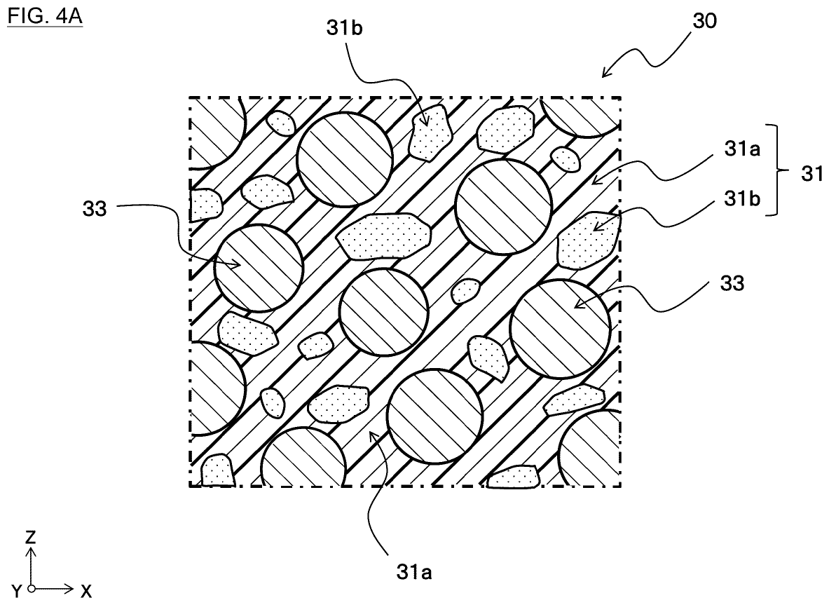

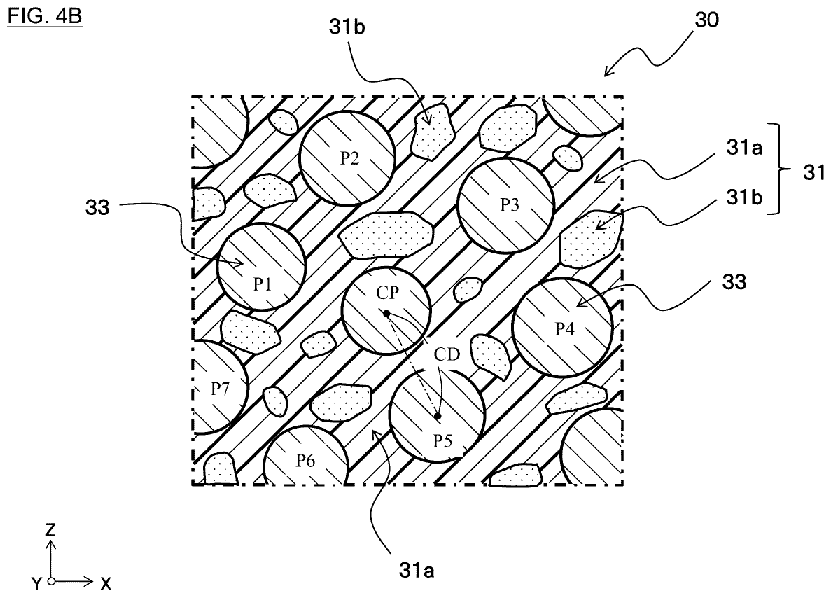

The discharge inducing portion 30 includes, as shown in FIG. 4A, at least a ceramic component 31 and metal particles 33. The ceramic component 31 preferably includes glass 31a, which is a base material, and ceramic particles 31b, which are non-glass. In the section of the discharge inducing portion 30 shown in FIG. 4A, the metal particles 33 and the ceramic particles 31b are dispersed in the glass 31a, which is the base material.

The metal particles 33 have a melting point (solidus temperature) that is higher than the firing temperature of the element body 10. Specifically, as the metal particles 33, Ag particles, Pd particles, Au particles, Pt particles, Cu particles, Ag—Pd alloy particles, Ag—Au alloy particles, Ag—Pt alloy particles, or the like can be used. The metal particles 33 preferably contain at least one of Pd, Ag, and Pt as a main component; and at least one of Pd particles, Pt particles, and Ag—Pd alloy particles is preferably used. In this context, the main component of each metal particle 33 constitutes preferably 30 wt % or more of the metal particle 33 or more preferably 50 wt % or more of the metal particle 33. The metal particles 33 in a section of the discharge inducing portion 30 have an average particle size d_{M} of preferably 2.0 μm or less or more preferably 0.05 μm or more and 2.00 μm or less. The area percentage of the metal particles 33 in a section of the discharge inducing portion 30 is preferably 10% or more and 50% or less or more preferably 15% or more and 30% or less.

The average particle size d_{M} and the area percentage of the metal particles 33 are calculated through an image analysis of a sectional photograph resulting from observation of a section of the discharge inducing portion 30 such as the one shown in FIG. 4A with a SEM, a STEM, or the like. When the average particle size d_{M} of the metal particles 33 is calculated, for example, preferably, equivalent circle diameters of at least one hundred metal particles 33 are measured to obtain particle size distribution of the metal particles 33. A particle size at a number-based cumulative frequency of 50% in the particle size distribution is calculated as the average particle size d_{M} of the metal particles 33. The area percentage of the metal particles 33 can be represented by (A_{M}/A_{AE})×100, where A_{AE} denotes the total area of the analyzed section of the discharge inducing portion 30 and A_{M} denotes the total area of the metal particles 33 included in the section. When the area percentage of the metal particles 33 is calculated, preferably, multiple sectional images are analyzed to set A_{AE} to at least 400 μm².

In a section of the discharge inducing portion 30, the average nearest inter-particle distance between the metal particles 33 may be 0.20 μm or more and 1.00 μm or less, preferably 0.25 μm or more and 0.81 μm or less, or more preferably 0.30 μm or more and 0.65 μm or less. Controlling the average nearest inter-particle distance within the above range enables more suitable compatibility between a low discharge start voltage and good ESD resistance while short circuits between the discharge electrodes are prevented.

The above nearest inter-particle distance is calculated using the following procedure. First, a center particle CP subject to measurement is freely selected (see FIG. 4B) from the metal particles 33 observed in a section of the discharge inducing portion 30. Then, one metal particle 33 that is nearest to the center particle CP is identified as a nearest particle from other metal particles 33 surrounding the selected center particle CP. For example, in the section shown in FIG. 4B, there are seven metal particles 33, which are denoted by P1 to P7, around the center particle CP; and the metal particle 33 denoted by P5 is the nearest particle.

Next, the centroid-to-centroid distance CD between the center particle CP and the nearest particle is measured, and the average particle size d_{M} of the metal particles 33 is subtracted from the centroid-to-centroid distance CD, to calculate the nearest inter-particle distance. That is, the nearest inter-particle distance between the center particle CP and the nearest particle denoted by P5 shown in FIG. 4B is represented by CD−d_{M}. Preferably, at least one hundred metal particles 33 are freely selected as center particles CP to perform the above measurement (i.e., the number of samples of the nearest inter-particle distances is at least one hundred) to calculate the average nearest inter-particle distance.

The glass 31a is present between the metal particles 33 and joins them. As the glass 31a is present between the metal particles 33, the glass 31a contributes to ensuring insulation between the metal particles 33 and compactness of the discharge inducing portion 30. The glass 31a constitutes preferably 10 wt % or more of the ceramic component (100 wt %) included in the discharge inducing portion 30 or more preferably 12 wt % or more thereof. The maximum value of the percentage of the glass 31a is not limited. The maximum value can be 100 wt % but is preferably 50 wt % or less.

The glass 31a may contain, for example, at least one selected from SiO₂, TiO₂, and an alkali earth metal component, as a main component. In this context, an alkali earth metal element is a general term for Be, Mg, Ca, Sr, Ba, or Ra; and the “alkali earth metal component” in the present embodiment means a compound containing an alkali earth metal element. The glass 31a may contain at least one alkali earth metal component. The alkali earth metal component contained in the glass 31a is preferably an oxide represented by a chemical formula MO, where “M” denotes an alkali earth metal element. In particular, as the alkali earth metal component, at least one selected from CaO, SrO, and BaO is preferably contained in the glass 31a.

In addition to the above main component, the glass 31a may contain other components, such as B₂O₃ and Al₂O₃. The other components may constitute any percentage. B₂O₃ may constitute, for example, 0.1 wt % to 20 wt % of the ceramic component (100 wt %) of the discharge inducing portion 30.

The glass 31a may also contain an alkali metal component, such as K₂O and Na₂O. However, the alkali metal component may promote particle growth of the metal particles 33. Thus, the alkali metal component of the discharge inducing portion 30 constitutes preferably 2 wt % or less of the ceramic component (100 wt %); or, more preferably, the glass 31a substantially does not contain the alkali metal component. The phrase “substantially does not contain the alkali metal component” means that the alkali metal component constitutes less than 0.1 wt % of the ceramic component. Note that alkali metal is a general term for Li, Na, K, Rb, Cs, or Fr; and the “alkali metal component” in the present embodiment means a compound containing an alkali metal element. Normally, the alkali metal component contained in the glass is Li₂O, Na₂O, K₂O, or the like.

The composition of the above glass 31a can be analyzed by various component analyses using, for example, energy-dispersive X-ray spectroscopy (EDX), an electron probe micro-analyzer (EPMA), electron diffraction with a TEM, laser ablation inductively coupled plasma mass spectrometry (LA-ICP-MS), or X-ray fluorescence analysis (XRF).

As described earlier, the ceramic component 31 of the discharge inducing portion 30 preferably includes the ceramic particles 31b, which are of a non-glass material, in addition to the glass 31a. Examples of materials of the ceramic particles 31b include semiconductor compounds (e.g., SnO₂ and RuO₂), dielectric compounds, zirconia (ZrO₂), and amorphous silica. More preferably, the ceramic particles 31b are zirconia particles. The ceramic particles 31b may have any average particle size d_{CA}. The average particle size d_{CA} is, for example, preferably 2.0 μm or less, or more preferably 0.01 μm or more and 1.0 μm or less.

In a situation where the ceramic particles 31b are zirconia particles, the ceramic particles 31b may constitute 0 wt % to 90 wt % of the ceramic component (100 wt %) of the discharge inducing portion 30 or preferably 10 wt % to 80 wt % thereof. In other words, the area percentage of the zirconia particles (the ceramic particles 31b) in a section of the discharge inducing portion 30 may be 0% or more and 85% or less or preferably 8% or more and 70% or less. Note that the ceramic particles 31b, such as the zirconia particles, dispersed in the glass 31a can be distinguished using, for example, a mapping analysis with EDX or an EPMA. Thus, the average particle size d_{CA} and the area percentage of the ceramic particles 31b are calculated through an analysis of a mapping image using a method similar to that of the metal particles 33.

Note that the discharge inducing portion 30 may have, other than the above ceramic component 31 and the above metal particles 33, pores having an average size of 1.0 μm or less.

The first external electrode 6 and the second external electrode 8 can each include a baked electrode layer, a resin electrode layer, a plating electrode layer, or the like. The first external electrode 6 and the second external electrode 8 may each constitute a single electrode layer or multiple laminated electrode layers. In general, a baked electrode layer or a resin electrode layer is provided as a base electrode in contact with the element body 10, and a single plating electrode layer or multiple plating electrode layers are provided on a surface of the base electrode.

In a situation where the baked electrode layer is provided, the baked electrode layer contains Ag, Cu, Pd, Au, Ni, or an alloy containing at least one of these metal elements, as a conductive material. Additionally, glass frit or oxide particles may be contained. In a situation where the resin electrode layer is provided, the resin electrode layer contains a conductive material similar to that of the above baked electrode layer and additionally a thermosetting resin. In a situation where the plating electrode layers are provided, the type and the number of the plating electrode layers are determined in view of a mounting method or usage environment of the transient voltage protection device 2. As the plating electrode layers, for example, Ni plating/Sn plating, Cu plating/Ni plating/Sn plating, Ni plating/Pd plating/Au plating, Ni plating/Pd plating/Ag plating, or Ni plating/Ag plating can be adopted.

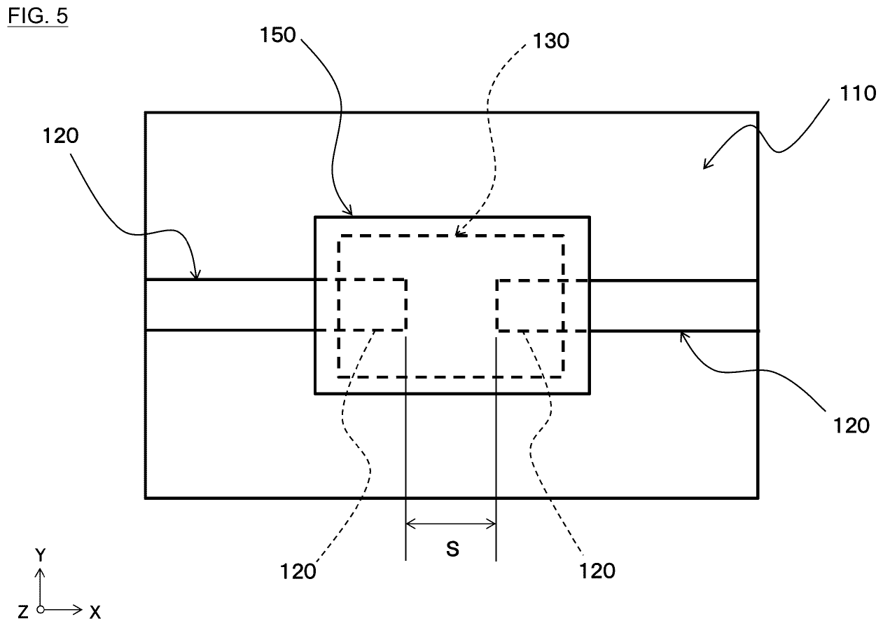

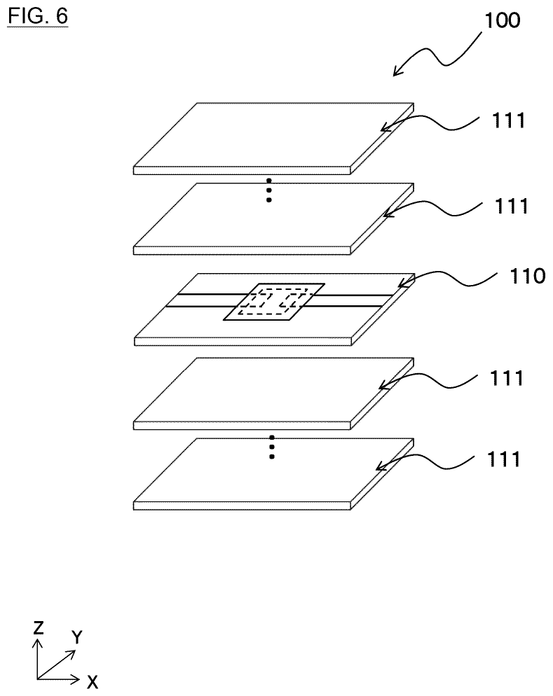

Now, an example method of manufacturing the transient voltage protection device 2 is described with reference to FIGS. 5 and 6.

First, an insulation layer slurry including constituent components of the insulation layers 11 is prepared. Specifically, a raw material powder of an insulating material (e.g., glass frit) is added to an organic vehicle including an organic solvent and an organic binder, and this mixture is kneaded to give the insulation layer slurry. Then, the slurry is applied to PET films using a doctor-blade method or the like and is appropriately dried to give green sheets. In the present embodiment, a sheet on which a discharge portion pattern is printed is referred to as a first green sheet 110, and sheets on which no discharge portion pattern is printed are referred to as second green sheets 111.

Then, a discharge inducing portion pattern 130 shown in FIG. 5 is formed on the first green sheet 110 using a discharge inducing portion paste. The discharge inducing portion paste is manufactured by kneading glass frit, which is a raw material of the glass 31a; a non-glass based ceramic powder (e.g., a semiconductor powder or a zirconia powder); a metal powder; and an organic vehicle.

Methods of kneading the discharge inducing portion paste are not limited. For example, a ball mill, a bead mill, a triple-roll mill, a homogenizer, or a high-pressure wet pulverizing apparatus may be used, or at least two of these apparatuses may be used in combination. In terms of improving dispersibility of the metal particles 33 in the discharge inducing portion 30, preferably, the high-pressure wet pulverizing apparatus is used to crush the raw materials of the discharge inducing portion paste, and further the triple-roll mill is used to knead the paste. Note that, in the kneading of the paste using the high-pressure wet pulverizing apparatus, the paste (slurry) introduced into the apparatus branches into two paths, and the branched paste undergoes oblique collision under pressure (max: 245 MPa) in a chamber. This kneading using the high-pressure wet pulverizing apparatus enables the raw materials (e.g., the glass frit, the non-glass based ceramic powder, and the metal powder) of the discharge inducing portion paste to be pulverized to improve dispersibility.

Note that the discharge inducing portion pattern 130 is formed using any of various printing methods (e.g., screen printing), transfer methods, application methods, or the like.

Next, conductor patterns 120 shown in FIG. 5 are formed on the first green sheet 110 using a discharge electrode paste. The discharge electrode paste is manufactured by adding a conductive powder, which is a raw material of the metal conductor portion 25, and a burn-out material for providing the pores 26 to an organic vehicle and kneading them. As the burn-out material, various resin beads, such as acrylic resin beads, carbon black, polystyrene, polyurethane, and polyvinyl benzene, can be used. Preferably, acrylic resin beads are used. The average size d_{P} and the area percentage of the pores 26 can be controlled based on particle sizes of the resin beads added to the discharge electrode paste and their proportion. Methods of kneading the discharge electrode paste are not limited. For example, a ball mill, a bead mill, a triple-roll mill, a homogenizer, or a high-pressure wet pulverizing apparatus may be used, or at least two of these apparatuses may be used in combination.

The conductor patterns 120 are formed along the X-axis direction so as to extend over a surface of the first green sheet 110 and a surface of the discharge inducing portion pattern 130. The conductor patterns 120 have a slit S having a predetermined width on the surface of the discharge inducing portion pattern 130. This slit S is a discontinuous portion where the conductor patterns 120 are not printed. The slit S becomes the gap G after firing. The conductor patterns 120 can be formed using a method similar to a method of forming the discharge inducing portion pattern 130.

Next, using a cavity lacquer, a cavity pattern 150 is formed on the first green sheet having the discharge inducing portion pattern 130 and the conductor patterns 120 printed. The cavity lacquer includes an organic solvent and an organic binder that burn out during firing. The cavity pattern 150 is used for forming an inner space between the opposing portions of the discharge electrodes. The cavity pattern 150 is formed so as to preferably cover part of the conductor patterns 120 that becomes the opposing portions 21b and 22b and the discharge inducing portion pattern 130, as shown in FIG. 5. The above steps give the first green sheet 110 having the discharge portion pattern printed, which includes the discharge inducing portion pattern 130, the conductor patterns 120, and the cavity pattern 150.

Next, the first green sheet 110 having the discharge portion pattern and the second green sheets 111 are laminated and pressed in the lamination direction to give a green chip 100. At this time, the first green sheet 110 is laminated between the second green sheets 111 as shown in FIG. 6. The number of the second green sheets 111 is not limited. The number of the second green sheets 111 above the first green sheet 110 and the number of the second green sheets 111 below the first green sheet 110 may be different.

Note that FIGS. 5 and 6 show a process of forming a single green chip for simplification of illustration. However, in actual manufacturing steps, normally, a green sheet having larger dimensions in an X-Y planar direction than those of the element body 10 is prepared, and multiple discharge portion patterns are continuously printed on a surface of this green sheet. Then, a mother laminated body is formed using this green sheet, and this mother laminated body is cut at predetermined intervals to give multiple green chips.

Next, the green chip 100 resulting from the above steps is subject to a firing treatment to give the element body 10. Conditions of the firing treatment are not limited. Conditions under which the element body 10 is sintered are selected according to the components included in the element body 10. For example, the holding temperature may be 800° C. to 1200° C. The temperature holding time may be 0.1 to 3 hours. The firing atmosphere may be air, an inert gas atmosphere, or a reducing atmosphere. During the firing treatment, the cavity pattern 150 burns out to form the cavity 15 there, where the cavity pattern 150 has been laminated. Also, the resin beads (burn-out material) in the conductor patterns 120 burn out during the firing treatment to form the pores 26 in the discharge electrodes 20. Note that, prior to the firing treatment, a binder removal treatment may be carried out as appropriate. In a situation where the reducing atmosphere is used for firing, a reoxidation treatment may be carried out after firing, or a heat treatment may be carried out to remove strain after firing.

Next, on the surfaces of the element body 10 resulting from the above steps, the external electrodes 6 and 8 are formed. Methods of forming the external electrodes 6 and 8 are not limited. For example, in a situation where baked electrode layers are formed as the external electrodes 6 and 8, a conductive paste including glass frit is applied to the end surfaces of the element body 10, and then the element body 10 is subject to a heat treatment under predetermined conditions (e.g., at 600° C. to 800° C. for 1 hour to 5 hours in air). In a situation where resin electrodes are formed as the external electrodes 6 and 8, a conductive paste including a thermosetting resin is applied to the end surfaces of the element body 10, and then the element body 10 is heated at a temperature at which the thermosetting resin hardens. After the baked electrodes or the resin electrodes are formed using the above method, sputtering, vapor deposition, electrolytic plating, electroless plating, or the like may be further carried out to give the external electrodes 6 and 8 having a multilayer structure.

The manufacturing process described above gives the transient voltage protection device 2 shown in FIG. 1.

### Summary of First Embodiment

The transient voltage protection device 2 according to the present embodiment includes the pair of discharge electrodes 20 opposing each other with the gap G therebetween and the discharge inducing portion 30 in contact with the pair of discharge electrodes 20. The discharge electrodes 20 have the pores 26 having an average size d_{P} of 0.45 μm or more and 2.04 μm or less.

Having the above characteristics, the transient voltage protection device 2 can have improved ESD resistance while maintaining a low discharge start voltage. A reason why ESD resistance improves is not necessarily clear but may be as follows.

While discharge electrodes in general preferably have a high density and high conductivity, it is assumed that the pores 26 of the discharge electrodes 20 of the transient voltage protection device 2 of the present embodiment work as inclusions obstructing transfer of electric charge, slightly increasing electrical resistance of the inside of the discharge electrodes 20, unlike conventional common general technical knowledge. That is, it is assumed that the pores 26 make electrical resistance at surfaces of the discharge electrodes 20 relatively lower than that of the inside, making it easier for a current to concentrate at the surfaces of the discharge electrodes 20. It is assumed that this disperses locations where electrical discharge occurs in the gap G between the discharge electrodes 20, improving ESD resistance.

The area percentage of the pores 26 in a section of the discharge electrodes 20 is preferably 1.0% or more and 12.4% or less. The above range of the area percentage of the pores 26 can further improve ESD resistance.

The discharge inducing portion 30 preferably includes the glass 31a, and the metal particles 33 and the ceramic particles 31b (e.g., zirconia particles), which are dispersed in the glass 31a. The above structure of the discharge inducing portion 30 can further improve ESD resistance while short circuits are prevented.

### Second Embodiment

A second embodiment of the present disclosure is described below with reference to FIG. 3B. Internal structures of discharge electrodes 20α of the second embodiment are different from those of the first embodiment; however, other structures of the second embodiment are similar to those of the first embodiment described earlier. Structures of the second embodiment common to the first embodiment are given the same reference numerals as in the first embodiment, and their description is omitted.

In the first embodiment, the discharge electrodes 20 have the pores 26 as the inclusions for increasing the electrical resistance of the inside. As such inclusions, instead of the pores 26, minute ceramic particles may be dispersed in the discharge electrodes 20. Specifically, the discharge electrodes 20α of the second embodiment include a metal conductor portion 25 and ceramic particles 27, which are scattered in the metal conductor portion 25, as shown in FIG. 3B.

The ceramic particles 27 included in the discharge electrodes 20α may contain, for example, silica (SiO₂), TiO₂, Al₂O₃, CaO, SrO, or BaO, or preferably contain silica as a main component. The main component of the ceramic particles 27 means a component included in the ceramic particles 27 at a highest percentage. In a situation where the main component of the ceramic particles 27 is silica, the ceramic particles 27 may be composed of only SiO₂ or may contain a trace element solid-dissolved.

The ceramic particles 27 have an average particle size d_{CE} of 0.05 μm or more and 0.54 μm or less, preferably 0.10 μm or more and 0.50 μm or less, or more preferably 0.15 μm or more and 0.40 μm or less. Dispersion of the ceramic particles 27 having an average particle size d_{CE} of 0.05 μm or more and 0.54 μm or less in the discharge electrodes 20α enables improvement of ESD resistance while a low discharge start voltage is maintained, as in the first embodiment. That is, the ceramic particles 27 work similarly to the pores 26 of the first embodiment.

Specifically, it is assumed that, similarly to the pores 26 of the first embodiment, the ceramic particles 27 having the predetermined average particle size d_{CE} work as inclusions obstructing transfer of electric charge inside the discharge electrodes 20α, slightly increasing electrical resistance of the inside of the discharge electrodes 20α. That is, it is assumed that the ceramic particles 27 make electrical resistance at surfaces of the discharge electrodes 20α relatively lower than that of the inside, making it easier for a current to concentrate at the surfaces of the discharge electrodes 20α. Also, it is assumed that a slight increase in electrical resistance of the inside of the discharge electrodes 20α by the ceramic particles 27 converts part of electrical energy of the discharge electrodes 20α into thermal energy. It is assumed that concentration of a current at the surfaces or/and conversion of electrical energy into thermal energy described above disperse locations where electrical discharge occurs in a gap G between the discharge electrodes 20α, improving ESD resistance.

The average thickness T_{DE} of the discharge electrodes 20α can be determined within a range similar to that of the average thickness of the discharge electrodes 20 of the first embodiment. The ratio (d_{CE}/T_{DE}) of the average particle size d_{CE} of the ceramic particles 27 to the average thickness T_{DE} may be, for example, 0.005 or more and 0.30 or less or preferably 0.01 or more and 0.10 or less. The area percentage of the ceramic particles 27 in a section of the discharge electrodes 20α is preferably 0.4% or more and 5.1% or less or more preferably 0.6% or more and 2.0% or less. The above range of the area percentage of the ceramic particles 27 can further improve ESD resistance.

The average particle size d_{CE} and the area percentage of the ceramic particles 27 are analyzed using a method similar to that of the pores 26. Specifically, an image analysis of a section of the discharge electrodes 20α is carried out to identify equivalent circle diameters of at least one hundred ceramic particles 27, and the average particle size d_{CE} is preferably calculated as an arithmetic mean. In the image analysis, the area percentage of the ceramic particles 27 can be represented by (A_{CE}/A_{DE})×100, where A_{DE} denotes the total area of the analyzed section of the discharge electrodes 20α and A_{CE} denotes the total area of the ceramic particles 27 included in the analyzed section. When the area percentage of the ceramic particles 27 is calculated, preferably, multiple sectional images are analyzed to set A_{DE} to at least 400 μm². Note that the metal conductor portion 25 and the ceramic particles 27 are distinguishable based on contrast in a SEM image or a STEM image of the section.

In a situation where the ceramic particles 27 are dispersed in the discharge electrodes 20α as well, a discharge inducing portion 30 preferably includes glass 31a, which is a base material, and metal particles 33 and ceramic particles 31b, which are dispersed in the glass 31a. In the second embodiment as well, the above structure of the discharge inducing portion 30 can further improve ESD resistance while short circuits are prevented.

### Third Embodiment

A third embodiment of the present disclosure is described below with reference to FIG. 3C. Internal structures of discharge electrodes 200 of the third embodiment are different from those of the first embodiment; however, other structures of the third embodiment are similar to those of the first embodiment described earlier. Structures of the third embodiment common to the embodiments described earlier are given the same reference numerals as in the embodiments described earlier, and their description is omitted.

As shown in FIG. 3C, the discharge electrodes 200 of the third embodiment include or have a metal conductor portion 25, and pores 26 and ceramic particles 27, which are scattered in the metal conductor portion 25. That is, the discharge electrodes 20s include or have both the pores 26 of the first embodiment and the ceramic particles 27 of the second embodiment as inclusions. Inclusion of both the pores 26 and the ceramic particles 27 in the discharge electrodes 200 can further improve ESD resistance more than the first embodiment or the second embodiment can.

Note that, in a situation where the discharge electrodes 20β include or have both the pores 26 and the ceramic particles 27 as well, the average size d_{P} and the area percentage of the pores 26 are determined preferably within the ranges described in the first embodiment, and the average particle size d_{CE} and the area percentage of the ceramic particles 27 are determined preferably within the ranges described in the second embodiment.

### Modified Examples

While the embodiments of the present disclosure have been described above, the present disclosure is not limited to the above embodiments and can be modified variously without departing from the gist of the present disclosure.

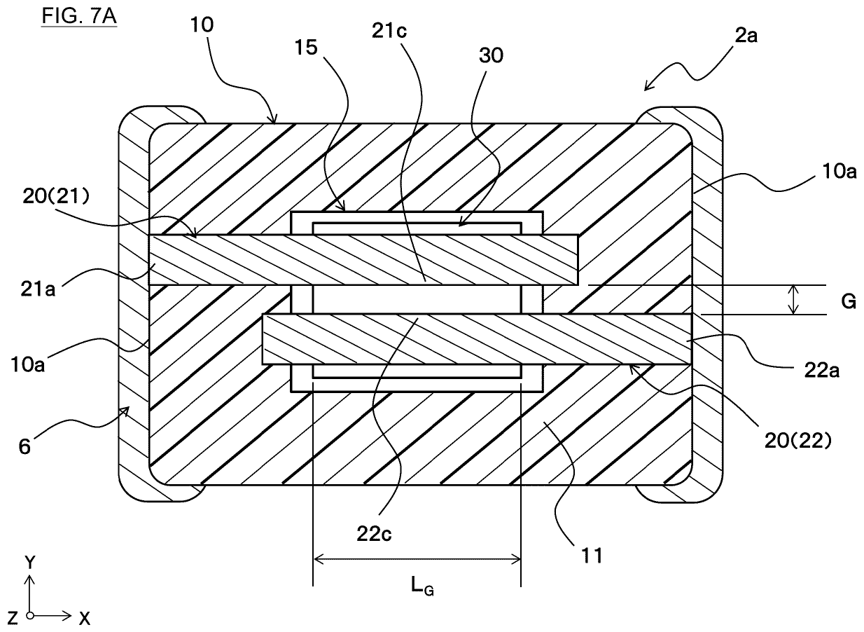

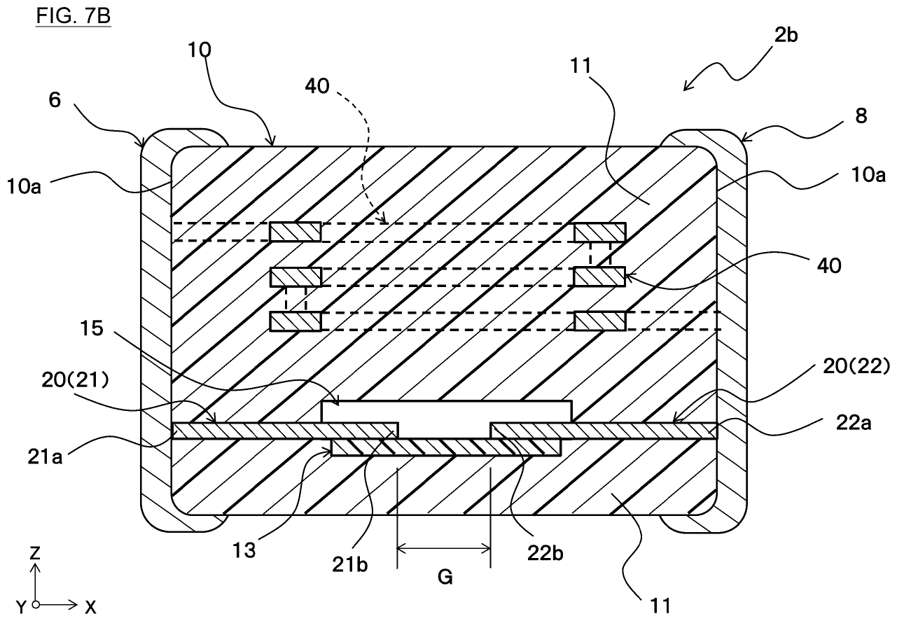

For example, the pair of discharge electrodes 20 may oppose each other in the Y-axis direction. In a transient voltage protection device 2a shown in FIG. 7A, a side edge 21c of a first discharge electrode 21 along the Y-axis direction and a side edge 22c of a second discharge electrode 22 along the Y-axis direction oppose each other with a gap G therebetween. That is, the side edges 21c and 22c are opposing portions, and electric discharge upon occurrence of a transient voltage (e.g., ESD) occurs between the side edges 21c and 22c. In a situation where the side edges 21c and 22c of the discharge electrodes 20 oppose each other as shown in FIG. 7A, the opposing portions of the discharge electrodes 20 on a discharge inducing portion 30 can have a larger length L_{G} than in a situation where their ends oppose each other. In the transient voltage protection device 2a shown in FIG. 7A, the ratio (L_{G}/G) of the length L_{G} of the opposing portions to the width of the gap G in the Y-axis direction can be 0.3 or more or is preferably 0.5 or more and 50 or less.

In FIGS. 2A and 2B, one cavity 15 is provided so as to cover the discharge inducing portion 30 and the opposing portions of the discharge electrodes 20; however, multiple cavities 15 may be provided over the discharge electrodes 20 and the discharge inducing portion 30 along the Z-axis. Also, provided that the pair of discharge electrodes 20, the discharge inducing portion 30, and the cavity 15 constitute a discharge unit, the element body 10 may include multiple discharge units. Also, it may be that the transient voltage protection device has no cavity 15, and between the discharge electrodes may be the discharge inducing portion 30.

The element body 10 may include a coil 40 as shown in FIG. 7B. The element body 10 may further include a capacitor unit. The capacitor unit can be provided by, for example, laminating internal electrode layers between the insulation layers 11.

### EXAMPLES

Hereinafter, the present disclosure is described based on further detailed examples. However, the present disclosure is not limited to these examples.

### Example 1

First, an insulation layer slurry, a discharge inducing portion paste, a discharge electrode paste, and a cavity lacquer were prepared. In the insulation layer slurry, glass and zirconia were included as raw material powders of insulation layers, together with an organic vehicle. The discharge inducing portion paste was manufactured by mixing an organic vehicle, glass frit, a Pd powder having an average particle size of 0.5 μm, and a zirconia powder having an average particle size of 0.05 μm and then kneading the mixture using a triple-roll mill. Note that, in the manufacture of the discharge inducing portion paste, the glass frit containing SiO₂, SrO, and CaO was used.

For the manufacture of the discharge electrode paste, as raw materials, a Pd powder having an average particle size of 0.5 μm, acrylic resin beads having an average particle size of 1 μm (burn-out material), and an organic vehicle were used. After these raw materials were mixed, the resultant mixture was kneaded using a triple-roll mill to give the discharge electrode paste. Note that the proportion of the acrylic resin beads was 3 vol % of the discharge electrode paste.

Next, using the above insulation layer slurry, green sheets were prepared. Then, to one of the green sheets, the discharge inducing portion paste, the discharge electrode paste, and the cavity lacquer were applied in the order mentioned to form discharge portion patterns.

Then, the green sheet having the discharge portion patterns printed and the green sheets with no discharge portion pattern were laminated in a predetermined order shown in FIG. 6 and were pressed in the lamination direction to give a mother laminated body. Then, the mother laminated body was cut to give green chips.

Then, the green chips were fired in an air atmosphere at 800° C. to 1200° C. for 0.1 hours to 1 hour to give element bodies (sintered bodies). Then, a conductive paste containing Ag was applied to outer surfaces of each element body, and the element body was heated at 700° C. for 1 hour, to form baked electrodes containing Ag. The above steps gave transient voltage protection devices having the structures shown in FIGS. 1 to 2B.

Note that the element bodies had a width of 1 mm in the X-axis direction, a length of 0.5 mm in the Y-axis direction, and a height of 0.5 mm in the Z-axis direction. A discharge inducing portion had an average thickness of 5 μm. Discharge electrodes had an average thickness of 5 μm. Between the discharge electrodes was a gap G having a width of 50 μm.

### Examples 2 and 3

In Examples 2 and 3, discharge electrode pastes were manufactured using a Pd powder (having the same specifications as those of Example 1), acrylic resin beads, and an organic vehicle (having the same specifications as those of Example 1) as raw materials, as in Example 1. However, the acrylic resin beads having a larger average particle size than that of Example 1 were used, and the proportion of the acrylic resin beads was higher than that of Example 1. Specifically, in Example 2, the acrylic resin beads having an average particle size of 1 μm were used, and the proportion of the acrylic resin beads was 12 vol %. In Example 3, the acrylic resin beads having an average particle size of 1 μm were used, and the proportion of the acrylic resin beads was 16 vol %.

In Examples 2 and 3, transient voltage protection devices were manufactured as in Example 1 except for the manufacturing conditions of the discharge electrode pastes, whose structures were different from those of Example 1 as described above.

### Examples 4 to 6

In Examples 4 to 6, discharge electrode pastes were manufactured with a silica powder added instead of the acrylic resin beads (burn-out material). Specifically, in Example 4, the silica powder having an average particle size of 0.05 μm was used, and the proportion of the silica powder was 1 vol % of the discharge electrode paste. In Example 5, the silica powder having an average particle size of 0.05 μm was used, and the proportion of the silica powder was 2 vol % of the discharge electrode paste. In Example 6, the silica powder having an average particle size of 0.05 μm was used, and the proportion of the silica powder was 7 vol % of the discharge electrode paste. Note that, as for a Pd powder and an organic vehicle of the discharge electrode pastes, the Pd powder and the organic vehicle having the same specifications as those of Example 1 were used.

In Examples 4 to 6, transient voltage protection devices were manufactured as in Example 1 except for the manufacturing conditions of the discharge electrode pastes, whose structures were different from those of Example 1 as described above.

### Examples 7 to 9

In Examples 7 to 9, discharge electrode pastes were manufactured with both acrylic resin beads and a silica powder added. In the discharge electrode pastes of Examples 7 to 9, a Pd powder and an organic vehicle having the same specifications as those of Example 1 were used.

In Example 7, acrylic resin beads having an average particle size of 1 μm and a silica powder having an average particle size of 0.05 μm were used. The proportion of the acrylic resin beads was 3 vol % of the discharge electrode paste. The proportion of the silica powder was 1 vol % thereof.

In Example 8, acrylic resin beads having an average particle size of 1 μm and a silica powder having an average particle size of 0.05 μm were used. The proportion of the acrylic resin beads was 12 vol % of the discharge electrode paste. The proportion of the silica powder was 2 vol % thereof.

In Example 9, acrylic resin beads having an average particle size of 1 μm and a silica powder having an average particle size of 0.05 μm were used. The proportion of the acrylic resin beads was 12 vol % of the discharge electrode paste. The proportion of the silica powder was 7 vol % thereof.

In Examples 7 to 9, transient voltage protection devices were manufactured as in Example 1 except for the manufacturing conditions of the discharge electrode pastes, whose structures were different from those of Example 1 as described above.

### Comparative Example 1

In Comparative Example 1, a discharge electrode paste that did not include a burn-out material or a ceramic powder was manufactured using only an organic vehicle and a Pd powder having an average particle size of 0.5 μm as raw materials of the discharge electrode paste. In Comparative Example 1, transient voltage protection devices were manufactured as in Example 1 except for the manufacturing conditions of the discharge electrode paste.

### Comparative Example 2

In Comparative Example 2, a discharge electrode paste was manufactured by mixing and kneading acrylic resin beads having an average particle size of 1 μm with a Pd powder (having the same specifications as those of Example 1) and an organic vehicle (having the same specifications as those of Example 1). In Comparative Example 2, the proportion of the acrylic resin beads was 25 vol %, which was higher than that of the above Examples. Transient voltage protection devices according to Comparative Example 2 were manufactured as in Example 1 except for the manufacturing conditions of the discharge electrode paste.

The following evaluation of the transient voltage protection devices of each Example and each Comparative Example was carried out.

### (Analysis of Discharge Electrodes)

The transient voltage protection devices were cut so as to give sections shown in FIG. 2A, and the sections resulting from cutting were mirror polished. The sections of the discharge electrodes were observed using a SEM to measure the average size of pores, the area percentage of the pores, the average particle size of ceramic particles, and the area percentage of the ceramic particles of the discharge electrodes. The average size of the pores was calculated by measuring equivalent circle diameters of one hundred pores. The average particle size of the ceramic particles was calculated by measuring equivalent circle diameters of one hundred ceramic particles. When the area percentage of the pores and the area percentage of the ceramic particles were calculated, the total area of an analyzed section of the discharge electrodes was set to 400 μm².

### (Evaluation of Discharge Characteristics)

The discharge start voltage (kV) and ESD resistance (kV) of each sample were measured using the electrostatic discharge immunity test defined by IEC 61000-4-2. A discharge start voltage of 2.3 kV or less was deemed good. An ESD resistance of 14 kV or more was deemed good, or an ESD resistance of 16 kV or more was deemed better.

Table 1 shows evaluation results of each Example and each Comparative Example. Note that “-” shown in some analysis result columns of the discharge electrodes in Table 1 indicates that the pores or the ceramic particles, which were inclusions, were not present in the discharge electrodes (the pores or the ceramic particles were not able to be observed at a magnification of ×5000).

TABLE 1

| | Discharge electrodes | | | | | |
|---|---|---|---|---|---|---|
| | Pores | | Ceramic particles | | Discharge | |
| | Average | Area | Average | Area | start | ESD |
| | size | percentage | size | percentage | voltage | resistance |
| Sample No. | (μm) | (%) | (μm) | (%) | (kV) | (kV) |
| Comparative Example 1 | — | — | — | — | 2.3 | 12 |
| Comparative Example 2 | 3.05 | 21.20 | — | — | 2.2 | 8 |
| Example 1 | 0.50 | 1.00 | — | — | 2.1 | 14 |
| Example 2 | 1.05 | 8.60 | — | — | 2 | 16 |
| Example 3 | 2.02 | 12.30 | — | — | 2.1 | 15 |
| Example 4 | — | — | 0.10 | 0.41 | 2.3 | 14 |
| Example 5 | — | — | 0.22 | 0.87 | 2.1 | 16 |
| Example 6 | — | — | 0.51 | 5.04 | 2.2 | 14 |
| Example 7 | 0.52 | 1.30 | 0.11 | 0.43 | 2.2 | 17 |
| Example 8 | 1.12 | 9.20 | 0.13 | 0.77 | 2.1 | 17 |
| Example 9 | 1.08 | 8.90 | 0.48 | 4.59 | 2.2 | 18 |

As shown in Table 1, in Comparative Example 1, no pores or ceramic particles were present in the discharge electrodes, and ESD resistance was less than 14 kV. In Comparative Example 2, although the pores having an average size of 3.05 μm were present in the discharge electrodes, ESD resistance was less than 14 kV.

In contrast, in Examples 1 to 3, it was confirmed that the discharge electrodes had the pores having an average size of 0.45 μm or more and 2.04 μm or less (an average size of 0.5 μm or more and 2.0 μm or less if rounded off to one decimal place) inside. In Examples 1 to 3, ESD resistance was 14 kV or more, which was higher than that of Comparative Example 1 and that of Comparative Example 2. The evaluation results of Examples 1 to 3 revealed that providing the discharge electrodes with the pores having an average size of 0.45 μm or more and 2.04 μm or less enabled ESD resistance to be improved while a low discharge start voltage was maintained. The evaluation results of Examples 1 to 3 also revealed that the area percentage of the pores in a section of the discharge electrodes was preferably 1.0% or more and 12.4% or less (range of 1% or more and 12% or less if rounded off to the nearest whole number).

In Examples 4 to 6, it was confirmed that the discharge electrodes included the silica particles having an average particle size of 0.05 μm or more and 0.54 μm or less (an average particle size of 0.1 μm or more and 0.5 μm or less if rounded off to one decimal place) inside. In Examples 4 to 6, ESD resistance was 14 kV or more, which was higher than that of Comparative Example 1 and that of Comparative Example 2. The evaluation results of Examples 4 to 6 revealed that dispersing the ceramic particles having an average particle size of 0.05 μm or more and 0.54 μm or less in the discharge electrodes enabled ESD resistance to be improved while a low discharge start voltage was maintained. The evaluation results of Examples 4 to 6 also revealed that the area percentage of the ceramic particles in a section of the discharge electrodes was preferably 0.4% or more and 5.1% or less.

In Examples 7 to 9, it was confirmed that the discharge electrodes had both the pores and the silica particles inside, and ESD resistance was better than that of Examples 1 to 6. These results revealed that dispersing both the pores and the ceramic particles having the predetermined sizes in the discharge electrodes enabled ESD resistance to be further improved.

### Examples 10 to 13

In Examples 10 to 13, transient voltage protection devices according to Examples 10 to 13 were manufactured with raw materials of discharge electrodes being changed from those of Examples described earlier. Detailed description follows.

In Example 10, the transient voltage protection devices were manufactured as in Example 2 except that a Pt powder having an average particle size of 0.5 μm was used instead of the Pd powder having an average particle size of 0.5 μm for manufacture of a discharge electrode paste.

In Example 11, the transient voltage protection devices were manufactured as in Example 5 except that a Pt powder having an average particle size of 0.5 μm was used instead of the Pd powder having an average particle size of 0.5 μm for manufacture of a discharge electrode paste.

In Example 12, the transient voltage protection devices were manufactured as in Example 8 except that a Pt powder having an average particle size of 0.5 μm was used instead of the Pd powder having an average particle size of 0.5 μm for manufacture of a discharge electrode paste.

In Example 13, the transient voltage protection devices were manufactured as in Example 8 except that a Ag—Pd alloy powder having an average particle size of 0.5 μm was used instead of the Pd powder having an average particle size of 0.5 μm for manufacture of a discharge electrode paste.

In Examples 10 to 13, the analysis of the discharge electrodes and the evaluation of discharge characteristics were carried out as in Examples 1 to 9. Table 2 shows those evaluation results.

TABLE 2

| | Discharge electrodes | | | | | | |
|---|---|---|---|---|---|---|---|
| | | Pores | | Ceramic particles | | Discharge | |
| | Metal | Average | Area | Average | Area | start | ESD |
| | conductor | size | percentage | size | percentage | voltage | resistance |
| Sample No. | portion | (μm) | (%) | (μm) | (%) | (kV) | (kV) |
| Comparative | Pd | — | — | — | — | 2.3 | 12 |
| Example 1 | | | | | | | |
| Comparative | Pd | 3.05 | 21.20 | — | — | 2.2 | 8 |
| Example 2 | | | | | | | |
| Example 10 | Pt | 1.54 | 8.70 | — | — | 2.1 | 19 |
| Example 11 | Pt | — | — | 0.28 | 0.95 | 2.2 | 19 |
| Example 12 | Pt | 1.62 | 9.80 | 0.16 | 0.82 | 2.2 | 21 |
| Example 13 | Ag—Pd | 1.02 | 8.80 | 0.11 | 0.71 | 2.2 | 17 |

As shown in Table 2, it was revealed that, even in a situation where the raw materials of a metal conductor portion differed, dispersing the pores and/or the ceramic particles in the discharge electrodes enabled ESD resistance to be improved while a low discharge start voltage was maintained. In particular, the results of Examples 10 to 12 revealed that inclusion of both the pores and the ceramic particles further improved ESD resistance more than inclusion of only either of the pores or the ceramic particles did. Moreover, it was revealed that use of Pt in particular for the discharge electrodes enabled ESD resistance to be further improved.

### REFERENCE NUMERALS

2, 2a, 2b . . . transient voltage protection device
10 . . . element body
10a . . . end surface
10b . . . side surface
10c . . . main surface
11 . . . insulation layer
20, 20α, 200 . . . discharge electrode
21 . . . first discharge electrode
22 . . . second discharge electrode
21a, 22a . . . lead-out portion
21b, 22b . . . opposing portion
25 . . . metal conductor portion
26 . . . pore
27 . . . ceramic particle (in discharge electrode)
30 . . . discharge inducing portion
31 . . . ceramic component
31a . . . glass
31b . . . ceramic particle (in discharge inducing portion)
33 . . . metal particle
15 . . . cavity
6 . . . first external electrode
8 . . . second external electrode
100 . . . green chip
110 . . . first green sheet
120 . . . conductor pattern
130 . . . discharge inducing portion pattern
150 . . . cavity pattern
111 . . . second green sheet

1-11. (canceled)

12. A transient voltage protection device comprising:
a pair of discharge electrodes opposing each other with a gap therebetween; and
a discharge inducing portion in contact with the pair of discharge electrodes,
wherein the pair of discharge electrodes has pores having an average size of 0.45 μm or more and 2.04 μm or less.

13. The transient voltage protection device according to claim 12, wherein an area percentage of the pores in a section of the pair of discharge electrodes is 1.0% or more and 12.4% or less.

14. The transient voltage protection device according to claim 12, wherein the discharge inducing portion comprises a base material comprising glass, metal particles dispersed in the base material, and ceramic particles dispersed in the base material.

15. The transient voltage protection device according to claim 12, wherein the pair of discharge electrodes further comprises ceramic particles having an average size of 0.05 μm or more and 0.54 μm or less.

16. The transient voltage protection device according to claim 12, wherein the pair of discharge electrodes comprises at least one selected from the group consisting of Pd, Ag, and Pt as a main component.

17. A transient voltage protection device comprising:
a pair of discharge electrodes opposing each other with a gap therebetween; and
a discharge inducing portion in contact with the pair of discharge electrodes,
wherein the pair of discharge electrodes comprises ceramic particles having an average size of 0.05 μm or more and 0.54 μm or less.

18. The transient voltage protection device according to claim 17, wherein an area percentage of the ceramic particles in a section of the pair of discharge electrodes is 0.4% or more and 5.1% or less.

19. The transient voltage protection device according to claim 17, wherein the ceramic particles comprise SiO₂ as a main component.

20. The transient voltage protection device according to claim 17, wherein the discharge inducing portion comprises a base material comprising glass, metal particles dispersed in the base material, and ceramic particles dispersed in the base material.

21. The transient voltage protection device according to claim 17, wherein the pair of discharge electrodes further has pores having an average size of 0.45 μm or more and 2.04 μm or less.

22. The transient voltage protection device according to claim 17, wherein the pair of discharge electrodes comprises at least one selected from the group consisting of Pd, Ag, and Pt as a main component.
